(19) United States
(12) Patent Application Publication
(10) Pub. No.: US 2015/0378699 A1
(43) Pub. Date: Dec. 31, 2015

(54) GRAPHICAL SCREEN ELEMENT

(71) Applicant: ROBERT BOSCH GMBH, Stuttgart (DE)

(72) Inventors: Clemens GUENTHER, Ettlingen (DE); Christoph NOACK, Schwieberdingen (DE); Ramon AMIRPOUR, Ebersbach (DE)

(21) Appl. No.: 14/766,695

(22) PCT Filed: Dec. 27, 2013
(86) PCT No.: PCT/EP2013/078043

§ 371 Date: Aug. 7, 2015

(30) Foreign Application Priority Data
Feb. 7, 2013 (DE) 10 2013 202 020.1

(51) Int. Cl. G06F 9/445

(52) U.S. Cl. CPC G06F 8/54

(57) ABSTRACT

A graphical screen element which is displayable on at least one screen of at least one computer device; with the aid of the screen element useful data for different application programs being manageable in a program-spanning manner; with the aid of the screen element the application programs being able to be linked together.

### FIELD OF THE INVENTION

The present invention relates to a graphical screen element. The present invention also relates to a method for managing useful data of application programs.

### BACKGROUND INFORMATION

In the related art, application suites, such as Microsoft Office for example, are known in which multiple different applications for different tasks are combined in a similar look and feel.

In a workshop environment, too, integrated applications are known which enable all tasks in a single user interface.

While in the first-mentioned case there is no link between the different applications and thus data may not be used jointly, in the second-mentioned case a considerable development effort is necessary in order to create all applications in such a way that they may be used in a single program.

Also known are input elements provided by operating systems, such as, for example, the Android Action Bar or the Windows Application Desktop Toolbar. However, the actions of these relate either only to the application which is presently active or to the operating system.

European Published Patent Application No. 0 933 700 describes a graphical control system for controlling non-computer-system devices. In this case, the graphical control system includes a computer, one or multiple interfaces relating to one or multiple non-computer-system devices, which have at least one feature control (or feature controller) and a coupling medium for coupling the computer to the interface(s), and a visual network operating system.

In the aforementioned workshop environment, often different tests have to be carried out on a vehicle (test object) using multiple (for example n) different applications. For this purpose, generally a precise identification of the test object is required. In the first-mentioned case, this step would have to be carried out n times at different locations in a different manner in the n applications due to the lack of communication between the applications.

There is thus a need for an efficient management of useful data for application programs.

### SUMMARY

According to a first aspect, the present invention provides a graphical screen element which:
is displayable on at least one screen of at least one computer device;
with the aid of the screen element useful data for different application programs being manageable in a program-spanning manner;
with the aid of the screen element the application programs being able to be linked together.

According to a second aspect, the present invention provides a method for managing useful data of application programs, which includes the following steps:
providing a superordinate graphical screen element for all application programs;
managing the useful data in a program-spanning manner with the aid of the screen element, useful data usable for all application programs being transmitted to all application programs in a superordinate manner with the aid of the screen element, the useful data being input and/or output with the aid of the screen element.

Preferred specific embodiments of the device are the subject matter of subclaims.

One preferred specific embodiment of the screen element according to the present invention provides that the useful data may be input via at least one operating element of the screen element, the useful data being transmittable to all application programs with the aid of the screen element. As a result, a convenient central input option for useful data for all application programs is provided.

Another preferred specific embodiment of the graphical screen element according to the present invention provides that the screen element is displayable on at least one screen of multiple computer devices on which the application programs are run. This helps to achieve the greatest possible consistency of useful data for multiple computer devices. In this way it is possible for a user to be able to view or manipulate program-spanning data of all application programs on all computer devices which are used.

Another preferred specific embodiment of the graphical screen element provides that the useful data are pieces of information and/or functions of the application programs. As a result, different data types may advantageously be exchanged between the application programs with the aid of the screen element.

Another preferred specific embodiment of the graphical screen element according to the present invention provides that the screen element is small in relation to the size of the screen. A good visibility and little optical interference with the screen element are thus made possible.

Another preferred specific embodiment of the screen element according to the present invention provides that the screen element is a bar. This supports a space-saving design and a functional and user-friendly handling of the graphical screen element according to the present invention.

Another preferred specific embodiment of the graphical screen element according to the present invention provides that at least one operating element includes one or multiple information panels and/or dialog elements. This supports a convenient and simple input of useful data.

Another preferred specific embodiment of the graphical screen element according to the present invention provides that it is usable for at least two mutually independent application programs. Versatile use of the graphical screen element is thus advantageously supported because it is not bound to a specific application program or to a specific choice of several application programs.

Another preferred specific embodiment of the screen element according to the present invention provides that the application programs are diagnostic applications in the motor vehicle sector. As a result, a highly beneficial use scenario in a workshop environment is covered, in which largely proprietary and different applications are used, which are linked together with the aid of the screen element.

Another preferred specific embodiment of the graphical screen element according to the present invention provides that the screen element is displayable essentially constantly during operation of the computer device. In this way, a permanent good overview of processes of the application programs results during the running of the application programs, which helps to keep the application programs free of errors.

One particular advantage of the present invention is that a central, superordinate location for displaying and configuring useful data for application programs is provided with the aid of the graphical screen element. Advantageously, in this way, a response of the application programs to the user may be displayed highly transparently, as a result of which the user's understanding of the application programs is increased. Advantageously, the screen element is an element which is completely independent of an operating system environment or computer platform and which is used only to provide or to exchange useful data in a platform-spanning manner between the individual applications. It may thus be regarded as a neutral location which allows a visualization and interaction of superordinate data. Detailed results from all application programs are thus advantageously visible in a superordinate manner.

Further features and advantages of the present invention are explained below on the basis of specific embodiments and with reference to the figures. All features described or shown form, by themselves or in any arbitrary combination, the subject matter of the present invention, regardless of their summary in the claims or their back reference and regardless of their wording or representation in the description and in the figures. The figures are primarily intended to illustrate the principles essential to the present invention. In the figures, identical reference numerals and signs denote identical or functionally equivalent elements.

### BRIEF DESCRIPTION OF THE DRAWINGS

FIG. 1 shows a schematic diagram of one specific embodiment of the graphical screen element.

FIG. 2 shows a schematic diagram of an interaction of the screen element according to the present invention with application programs.

FIG. 3 shows a schematic flow chart of one specific embodiment of the method according to the present invention.

### DETAILED DESCRIPTION

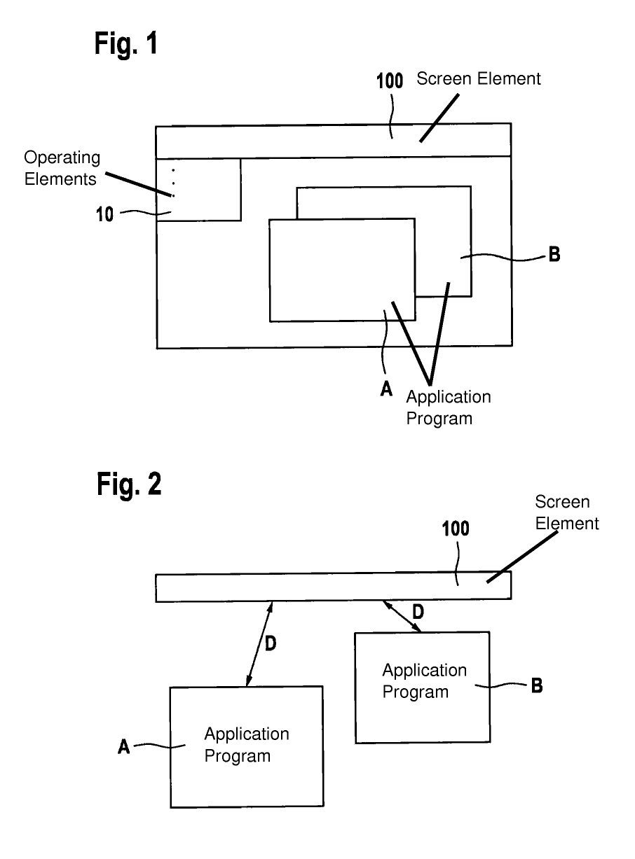

FIG. 1 shows a schematic diagram of one specific embodiment of graphical screen element 100 according to the present invention. Preferably, screen element 100 is designed as a screen bar or bar on a screen of a computer device (not shown) and is displayed constantly during operation. Advantageously, the screen bar may be situated in a top edge area of the screen, although a positioning of screen element 100 is essentially freely selectable so that a specific positioning may also depend on space conditions or other requirements. Advantageously, the screen bar has fold-out operating elements 10, for example in the form of information panels or communication menus, with the aid of which useful data for different application programs A and B may be input by a user.

Graphical screen element 100 is thus a kind of multi-application bar which is displayed constantly and at a fixed position on the screen of a computer and may contain frequently required pieces of information/functions relating to application programs A, B, and different application programs may be “linked together,” so to speak, using these pieces of information/functions.

A type of interaction of application programs A, B with graphical screen element 100 according to the present invention is shown schematically in FIG. 2. It is apparent that application programs A, B exchange useful data D (for example in the form of pieces of information and/or context-specific functions) with graphical screen element 100, i.e., deliver these to screen element 100 and obtain them from the latter. In this way, with the aid of graphical screen element 100, a user is always provided with the most up-to-date useful data D for viewing and/or manipulation purposes.

As examples of application programs A, B, diagnostic applications in a workshop environment should be mentioned, which are often configured very differently and/or in a proprietary manner and may be linked together centrally and in a superordinate manner with the aid of graphical screen element 100.

Advantageously, graphical screen element 100 is independent of a type of use of a computer (for example workstation computer, office computer, etc.) and also independent of the type of computer used (for example embedded computer, tablet computer, standard PC, desktop, etc.). Advantageously, graphical screen element 100 according to the present invention is also independent of a manufacturer of application programs A, B and also independent of whether application programs A, B are or are not run on the same computer/operating system account.

For example, it is conceivable that multiple diagnostic applications/measuring modules are managed/run by a single computer platform and also that multiple computer devices are networked with one another via a network, whereby graphical screen element 100 according to the present invention is displayed on each computer device and in this way is provided for good data consistency between the individual computer devices and application programs A, B.

Advantageously, therefore, application-spanning pieces of information, such as, for example, object features and/or status information, are presented always at the same location and always in a visible manner with the aid of graphical screen element 100.

Furthermore, graphical screen element 100 combines optically and functionally different applications to form an overall program suite. As a result, all connected application programs A, B appear as a homogeneous suite, without these having to be redeveloped.

This advantageously saves time due to the omission of multiple inputs of the same data, as a result of which the possibility of input errors is minimized. Advantageously, a central location for configuring applications and associated application-specific hardware is provided with the aid of graphical screen element 100.

In this way, the status and progress of processing with the aid of application programs A, B may be displayed centrally in a highly visible manner.

Of course, it is also conceivable that graphical screen element 100 is also designed differently than what has been described above. For example, a different type of geometric form is conceivable. It is also conceivable that, depending on the user's wishes, the display of screen element 100 on the screen may be hidden at least temporarily so as to utilize a screen surface in the best possible way for an application program A, B.

As a result, the graphical screen element according to the present invention provides a user with pieces of information about different application programs at all times, which are used jointly by all application programs A, B. It thus represents, virtually, a comprehensive information interface which centrally receives, outputs and links together useful data for all application programs A, B used.

Advantageously, the graphical screen element or operating element according to the present invention thus represents a superordinate location which provides results of all applications centrally for viewing and manipulation purposes. Advantageously, these results may be viewed on any computer device by any person.

Advantageously, the graphical screen element according to the present invention is relatively small in relation to the size of the overall screen, so that a clarity and user-friendliness is therefore advantageously increased, for example in a taskbar which takes up no more than 10% of the screen.

As an example of useful data D for display by graphical screen element 100, the following pieces of information are conceivable:

Customer: . . . Vehicle: . . . Vehicle model: . . . License plate: . . . Test task: . . .

Advantageously, with the aid of graphical screen element 100 according to the present invention, it may also be provided to input in each case only specific useful data D which are necessary for one specific application program A, B, so that these specific useful data D are transmitted only to the aforementioned application program A, B. A further advantage obtained is therefore that the different application programs A, B may optionally receive different useful data D, which are entered at a central location with the aid of graphical screen element 100 according to the present invention.

As a further variant, it is also conceivable that graphical screen element 100 is designed as a separate monitor which is used solely for this purpose.

Intermediate results of the individual application programs A, B may thus also be continuously collected, output or forwarded to other application programs A, B.

As one exemplary scenario, for example, it is possible to consider an initiation of a repair or diagnosis process for a motor vehicle, during which initially all data required by all diagnostic applications are acquired once (for example by service reception personnel) and working processes are defined once. In this way, throughout the entire diagnosis or repair process, there is no further need to input any customer data again, which advantageously increases data consistency and the freedom from errors in the processes involved.

Another exemplary scenario is, for example, that a motor vehicle is tested by multiple computer devices, on each of which a different test application is carried out. It is also conceivable that multiple motor vehicles are tested by a single test application (for example a long-term test).

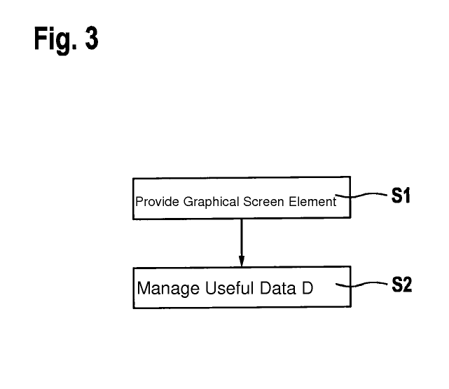

FIG. 3 shows a schematic flow chart of one specific embodiment of the method according to the present invention for managing useful data of application programs.

In a first step S1, a graphical screen element 100 is provided which is superordinate for all application programs A, B.

In a second step S2, a program-spanning management of useful data D is carried out with the aid of screen element 100, whereby useful data D which are used for all application programs A, B are transmitted in a superordinate manner to all application programs A, B, useful data D being input and/or output with the aid of screen element 100.

In summary, the present invention provides a graphical screen element for increasing the efficiency of and for optimizing processes of application programs in that data for the application programs are managed and linked together centrally with the aid of the screen element. Advantageously, this takes place in a form which is easily understood by a user, so that a visualization and interaction is provided for all application-program-spanning data. In this way, a user is saved many different steps and is always presented with important application-spanning pieces of information and offered direct processing.

Although the present invention has been described on the basis of preferred exemplary embodiments, it is not limited thereto. In particular, the computer device may also be integrated into a screen and need not necessarily be a separate device.

Those skilled in the art will thus suitably modify or combine together the described features of the present invention without departing from the core of the present invention.

1.-14. (canceled)

15. A graphical screen element, wherein the graphical screen element:
is displayable on at least one screen of at least one computer device;
allows useful data for different application programs to be managed in a program-spanning manner with the aid of the screen element; and
allows the application programs to be linked to one another with the aid of the screen element, wherein an input of the useful data takes place via at least one operating element of the screen element, and wherein a transmission of the useful data to all application programs takes place with the aid of the screen element.

16. The graphical screen element as recited in claim 15, wherein the screen element is displayable on at least one screen of multiple computer devices on which the application programs are run.

17. The graphical screen element as recited in claim 15, wherein the useful data are at least one of pieces of information and functions of the application programs.

18. The graphical screen element as recited in claim 15, wherein the screen element is small in relation to a size of the screen.

19. The graphical screen element as recited in claim 15, wherein the screen element is a bar.

20. The graphical screen element as recited in claim 15, wherein the at least one operating element includes at least one of at least one multiple information panel and at least one dialog element.

21. The graphical screen element as recited in claim 15, wherein the graphical screen element is usable for at least two mutually independent application programs.

22. The graphical screen element as recited in claim 15, wherein the application programs are diagnostic applications in a motor vehicle sector.

23. The graphical screen element as recited in claim 15, wherein the screen element is displayable essentially constantly during operation of the computer device.

24. A computer device, comprising:
at least one screen provided with a graphical screen element, wherein the graphical screen element:
is displayable on at least one screen of at least one computer device;
allows useful data for different application programs to be managed in a program-spanning manner with the aid of the screen element; and
allows the application programs to be linked to one another with the aid of the screen element, wherein an input of the useful data takes place via at least one operating element of the screen element, and wherein a transmission of the useful data to all application programs takes place with the aid of the screen element.

25. The computer device as recited in claim 24, wherein at least two mutually independent application programs can be run on the computer device, and wherein useful data of a first application program are transmittable to a second application program essentially in real time with the aid of the screen element.

26. A computer system, comprising:
multiple computer devices, each computer device, comprising:
at least one screen provided with a graphical screen element, wherein the graphical screen element:
is displayable on at least one screen of at least one computer device;
allows useful data for different application programs to be managed in a program-spanning manner with the aid of the screen element; and
allows the application programs to be linked to one another with the aid of the screen element, wherein an input of the useful data takes place via at least one operating element of the screen element, wherein a transmission of the useful data to all application programs takes place with the aid of the screen element, wherein the graphical screen element is displayable on the screen assigned to the respective computer device, and wherein different useful data (D) managed by the screen element is displayable on each computer device with the aid of the screen element, depending on the application program.

27. A method for managing useful data of application programs, comprising:
providing a superordinate graphical screen element for all application programs; and
managing the useful data in a program-spanning manner with the aid of the screen element, wherein the useful data usable for all application programs are transmitted to all application programs in a superordinate manner with the aid of the screen element, wherein the useful data are input with the aid of at least one operating element of the screen element, and wherein the useful data is transmitted to all application programs via the screen element.

28. A computer program product including program code for carrying out, when the program code runs on an electronic computer or is stored on a computer-readable data carrier, a method for managing useful data of application programs, the method comprising:
providing a superordinate graphical screen element for all application programs; and
managing the useful data in a program-spanning manner with the aid of the screen element, wherein the useful data usable for all application programs are transmitted to all application programs in a superordinate manner with the aid of the screen element, wherein the useful data are input with the aid of at least one operating element of the screen element, and wherein the useful data is transmitted to all application programs via the screen element.
